(19) United States
(12) Patent Application Publication
(10) Pub. No.: US 2009/0281889 A1
(43) Pub. Date: Nov. 12, 2009

(54) DISPLAYING TARGETED ADS IN UNUSED AREAS OF BROWSER WINDOWS AND USING USER PREMISSSIONED PERSONAL PRIVATE INFORMATION IN CONNECTION WITH WEIGHTED DISPLAY OF ADS, ONLINE SEARCH RESULTS AND SEARCH ADS

(76) Inventor: H. Anthony DEROSA-GRUND, Magnolia, TX (US)

Correspondence Address: CONLEY ROSE, P.C.;David A. Rose, P. O. BOX 3267, HOUSTON, TX, 77253-3267, US

(21) Appl. No.: 12/243,703

(22) Filed: Oct. 1, 2008

Related U.S. Application Data
(60) Provisional application No. 61/051,198, filed on May 7, 2008.
(60) Provisional application No. 61/053,875, filed on May 16, 2008.

(51) Int. Cl. G06Q 30/00; G06Q 10/00; G06F 17/00; G06F 3/048

(52) U.S. Cl. 705/14.25; 705/10; 705/30; 705/14.39; 705/14.54; 705/14.66; 715/234; 715/768; 715/766

(57) ABSTRACT

A method comprises obtaining a user profile from a user who registers with an online service, providing the user profile to an ad server, receiving from the ad server a targeted ad based on the user profile, and displaying the targeted ad in an unused area of a browser window as an overlay to the browser window while the user views a page from a website or search results from a search engine

### CROSS-REFERENCE TO RELATED APPLICATIONS

This patent application claims priority to provisional patent applications having U.S. Ser. Nos. 61/051,198 (filed May 7, 2008) and 61/053,875 (filed May 16, 2008), each of which is incorporated herein by reference.

### BACKGROUND

With the proliferation of the Internet has come widespread, online advertising. In the U.K., for example, the Internet will usurp television as the biggest advertising medium by the end of 2009, according to a report published by the Internet Advertising Bureau (IAB) in May of 2008. Britain has the most developed online advertising market in the world, which the report by the IAB, PricewaterhouseCoopers and the World Advertising Research Centre said was worth 2.8 billion pounds ($5.6 billion) in 2007. It said last year's 38 percent online ad growth was driven by the rising number of people online, the introduction of cheap laptops and the growing popularity of catch-up TV on the Internet through services such as Channel 4's 4oD. “With broadband speeds on the up and consumers spending more time on more sites, the outlook for online advertising is rosy—in fact we expect it to overtake TV in 2009 when it will become the UK's biggest medium,” IAB chief executive Guy Phillipson said in a statement.

The global outlook for Internet advertising growth has prompted some journalists to recently dub “Internet Advertising” as “The New Oil.” This is not just an anecdotal observation; it is backed up by a significant amount of data and research. According to “The Kelsey Group's Annual Forecast (2007-2012) of Feb. 28, 2008: Outlook for Directional and Interactive Advertising,” for example, interactive advertising revenues will increase significantly from US$45 billion in 2007 to US$147 billion globally in 2012, representing a 26.8 percent compound annual growth rate (CAGR). “It is no surprise that the global advertising industry is experiencing a full-scale shift to mixed-media platforms, with interactive driving a significant share of overall industry growth,” said Matt Booth, senior vice president, Interactive Local Media, The Kelsey Group. “We see Internet development—including increased subscriber/user access and broadband penetration—as a driver of both interactive advertising revenue as well as migration of traditional ad spending to new media platforms.” Interactive advertising, which comprises search (including local search), display advertising, classifieds and other interactive ad products, grew its share of global advertising revenues from 6.1 percent in 2006 to 7.4 percent in 2007. Kelsey Group analysts expect the interactive share of global ad spending will reach 21 percent by 2012. During the forecast period (2007-2012), the United States will see interactive advertising revenues grow from US$22.5 billion to US$62.4 billion (22.6 percent CAGR), with interactive revenues in Canada increasing from US$1.3 billion to US$3.3 billion (21.3 percent CAGR).

The number of ad pages on the web is not growing at the same rate as is the movement of media dollars previously spent on traditional media (newspapers, radio and television) to Internet Advertising. To accommodate this shift, this virtual Internet Advertising “Gold Rush” has led to many of the largest Internet Service Providers (ISP's) and Portal/Internet Ad Sales entities to engage in some questionable practices to accommodate the limited supply, and exponentially greater demand, of Internet advertising.

On the more sedate end of the spectrum, realizing the ever increasing value of Internet advertising, some companies have attempted to increase the value of their existing advertising inventory by targeting their advertisements to those potential customers believed to be the most likely to purchase the advertised product or service. This so-called “targeted advertising” paradigm requires an assessment of the on-line user's demographic data (e.g., age, location, gender, etc.). This is achieved by either asking the consumer to freely give the data to the Internet Advertising company (which most choose not to do as there is no benefit, or upside, for the consumer to do so), or the advertiser/portal must extrapolate this data from the users' search and “click” patterns, which is generally done without the users' knowledge or permission. It has been reported that Google has built its business on a highly sophisticated algorithm that runs on a system utilizing massive computing power, which extrapolates such demographic data (i.e., gender, age, interests, etc.,) by analyzing consumers' click and search patterns. Google determines each consumer's location from the IP address (which Google records) in order to target what ads it estimates, through its algorithm, are most appropriate for that particular consumer. At the end of the day, some may regard this method as effective. However, in the final analysis Google's algorithm is just that, an algorithm—a highly educated guess. It is important to note that this guess is totally derived from data that belongs to the consumer and not to Google.

End user data privacy is vitally important, as is maintaining an “unaltered” and unaudited experience for users on the “Net.” Users do not want their private data, their search patterns and what sites they visit used without their permission. Unfortunately, this is exactly what is happening to Internet users with alarming frequency in today's environment.

“Net Neutrality” is the principle that Internet users should be able to access any web content they choose and use any applications they choose, without restrictions or limitations imposed by their Internet service provider. Net Neutrality means that ISP's should not engage in any activity that restricts, alters or redirects an Internet user's access to and interaction with websites/internet content in any way whatsoever. Additionally, users do not want their Internet Service Provider (ISP) hijacking, redirecting or altering their access to the Internet, and then in turn profiting from it by replacing a site's existing ads with their own—or even worse hijacking the user's browser and then shrinking the browser window to make room for the ads—all without the permission of the user. These are the types of the more nefarious methodologies that are becoming the norm, rather than the exception. In today's environment, companies try not only to squeeze out every dollar from existing advertising inventory by making it more valuable, and thus costly with acceptable practices like targeted advertising, but they are starting to cross the line of Net Neutrality at the expense of the consumer.

There are other companies like Phorm in the U.K. and NebuAd in the U.S. that use existing technologies like DPI (Deep Packet Injection) to contravene a user's net neutral web traffic and then read a website's source code in order to strip out a site's ads and replace them with their own. Companies like Phorm place equipment at the I.S.P.'s “head end” that intercepts the user's browser when it visits a Web site for the first time. It redirects the browser to Phorm's own site. In that way, it can inject and read its own cookie with a Phorm identification number. Phorm then appends this number onto the cookie of the other site without the permission of that other site. In doing so, Phorm then reads that site's code and with a bit of Java script strips out that site's own advertising and inserts Phorm's own in its place.

Phorm has set off a firestorm of criticism in the UK from the press, civil rights groups and Internet users. Simply put, three of the UK's largest ISPs (Virgin Media, BT and TalkTalk) did an unpublicized deal with Phorm to install the system at their “head ends.” The end result was that the private browsing history of millions of Internet users was given over to Phorm without the users' permission—and in real time.

Other companies take a different approach to achieving the same end result. Companies like Perftech in the US also place “black boxes” at the head end of the ISP, and in decisively non-net neutral manner significantly shrink the user's entire web browser window to generate advertising opportunities on the ISP's own home page. Similarly Perftech will take misdirected or mistyped URL's by the user and instead of displaying a standard “404” error message in the user's browser actually hijacks and redirects the user's browser to a page, replete with its own advertising owned and corralled in collaboration with the user's ISP, all for their own gain and at the expense of the user's right to a new neutral access to the Internet.

Few, if any on-line advertisers engage in ad injection in a manner that maintains “Net Neutrality.” By definition, ad injection by its very nature crosses over the line of net neutrality. The issue of maintaining “net neutrality” is of such great concern that some legislative bodies are attempting to enact legislation targeting some of the non-net neutral advertising practices employed today. The technique described herein, on the other hand, was purposefully engineered to operate in a 100% Net Neutral manner.

Just how lucrative can ad injection be for a company? According to a NY Times article of Feb. 18, 2008, customers of BT, Carphone Warehouse and Virgin Media can opt out of the Phorm's new system with great difficulty. However, they will be encouraged to stay under the spin put out by Phorm of “being given a higher level of protection against online fraud.” Analysts at Investec Securities said that Phorm could generate £85 million, or $167 million, in annual revenue for BT alone by 2009. Since Phorm's own website indicates their model is to split this stream with ISP, BT users would be expected to generate a like amount for Phorm.

NebuAd is well funded as companies like Menlo Ventures was joined by Sierra Ventures in NebuAd's Series B round of investment, bringing the total raised by the company to $30,000,000 which the company will use to fund the company's acceleration into the online advertising market.

Good for the companies, their partners and investors. Bad for consumers and website owners. Analysts said that in the short term, that Phorm and similar services would allow Web publishers to charge higher rates for advertising, because ads on their sites would become more relevant. Over the longer term, however, they could undermine Web content owners by letting service providers wrest away control of ad sales. This is evidenced by the larger and vociferous public outcry in the UK since forums launched with consumers calling for everything from boycotts of their ISP to governmental investigation of the Phorm/ISP usage of their private data.

How to properly take advantage of the opportunity currently in the lucrative Internet advertising market? The answer is to find a method that exactly matches ads with consumers that the user proactively accepts and participates in as a partner, compensates him/her for viewing ads (rather than lining pockets of the ISP at the consumers expense), while protecting consumer data at all times and simultaneously not altering existing web content in any way shape or form. The creator of the World Wide Web, Tim Berners-Lee, has criticized the idea of tracking his browsing history saying that “It's mine—you can't have it. If you want to use it for something, then you have to negotiate with me. I have to agree, I have to understand what I'm getting in return.” The preferred embodiments provided below address these issues.

### BRIEF DESCRIPTION OF THE DRAWINGS

For a detailed description of exemplary embodiments of the invention, reference will now be made to the accompanying drawings in which:

FIG. 1 shows a method and apparatus for operating targeted online advertising by means of a novel and unique method for creating advertising space in the unused area within a web browser in accordance with various embodiments of the invention;

FIG. 2 shows a conventional web browser window and web page with unused areas;

FIG. 3 shows a screen layout depicting how the unused areas can be divided into rectangles into which targeted ads are provided;

FIG. 4 shows a web browser window in accordance with the preferred embodiments in which targeted ads have been placed in the screen areas that were otherwise unused by a website within a web browser; and

FIG. 5 shows operational flow of the client code.

### DETAILED DESCRIPTION

Disclosed herein is a system that provides targeted advertising to electronics consumers. The advertising is targeted to either closely or exactly match the user's demographics (e.g., age, sex, race, profession, etc.). In at least some embodiments, the system provides advertising to computer users via Web browsers, although in other embodiments, the advertising also may be provided via other computer software, via televisions, other electronic products, etc. In preferred embodiments, the advertising is provided to a computer user's Web browser without modifying the source code of any Web sites. No Web site ads are stripped and replaced and no Web sites are reduced in size to make space for ads.

In accordance with various embodiments, the system disclosed herein generates an overlay for Web browsers. The overlay populates with ads otherwise unused or unpopulated areas of a Web browser, e.g., areas between the outer boundaries of a Web site being displayed and the inner edges of the frame of the Web browser window. The system includes a software client, downloaded to a computer by a user, which determines the computer display's current screen resolution. The client transfers the screen resolution information to another machine, like one or more remote servers, that provides the client with targeted advertising. In turn, the client generates a Web browser overlay using the advertising for display to the user. This advertising scheme generates revenue for an online service that implements the functionality herein. Part of the revenue is paid to the user (e.g., in exchange for the user's cooperation in downloading, installing and using the advertising client).

Further, if the screen resolution is not suitable for displaying advertising, the advertising will appear superimposed over some browser content (thus blocking or obscuring such browser content), but will temporarily become transparent in order to view the underlying browser content when the mouse pointer is placed over the ads.

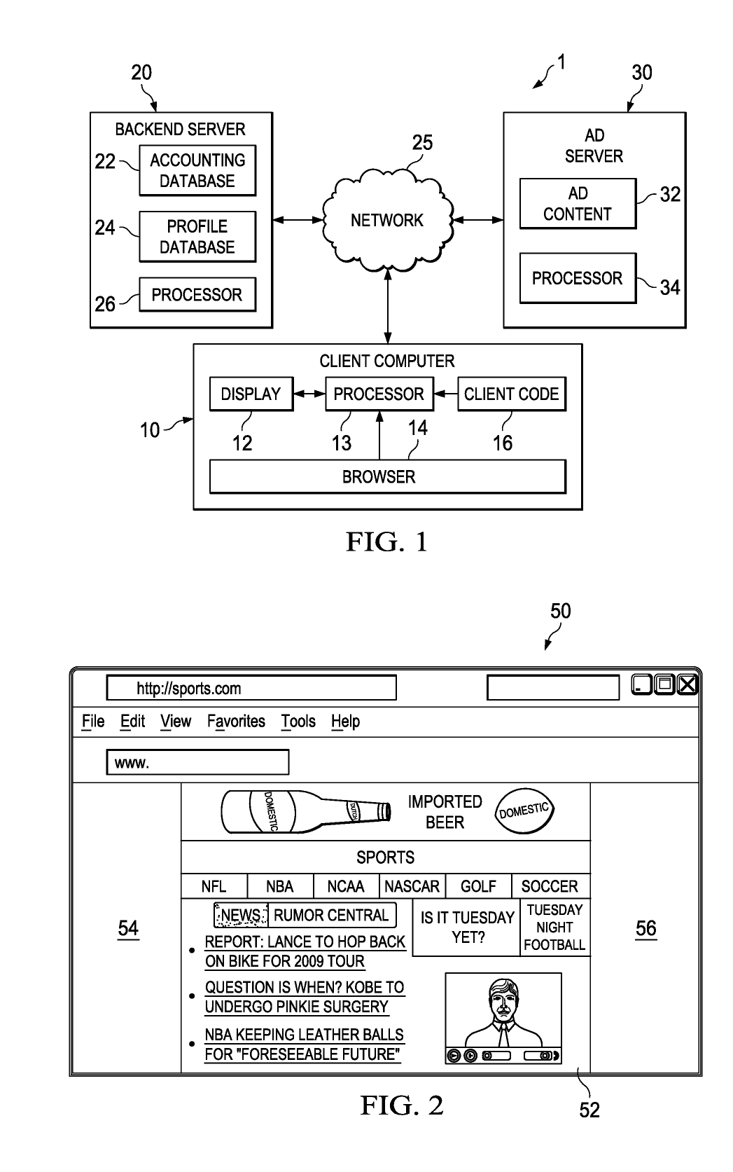

FIG. 1 shows an illustrative system 1 comprising a client computer 10 communicatively coupled to a back-end server 20 and ad server 30 via network 25 (e.g., the Internet). The back-end server 20 and ad server 30 may be owned and controlled by the same organization or owned and controlled separately. Although a single client computer 10 is shown, the targeted advertising system described herein works with any number of client computers and corresponding users.

The client computer 10 comprises a display 12, a processor 13, Web browser software 14 and client code 16. The browser 14 and client code 16 are executed by the processor 13. Websites and targeted ads may be shown on the display 12 independently but optimized in an “overlay mode.” The client computer 10 may be a desktop computer, notebook computer, hand-held computer (e.g., personal digital assistant), server, etc. Whenever software code is described herein as performing an action (regardless of which machine stores that software code), it should be understood that the software code may not perform the action in and of itself, but instead may be executed by a processor which performs that action.

The back-end server 20 contains an accounting database 22 and a profile database 24. The databases 22 and 24 are accessed, processed or otherwise executed by a processor 26. The ad server 30 contains a processor 34. The ad server 30 further comprises ad content 32 (e.g., ads in digital form) that is to be provided to a user of the client computer 10 with the assistance of the back-end server 20.

A user registers with an online targeted advertising service via the profile database 24. The registration process entails the user providing various pieces of information such as name, address, age, gender, ethnic background, income, interests, etc. The user provides such information to the profile database 24 which in turn creates a financial account in the accounting database 22 and a user profile in the profile database 24 for that user with the various pieces of user-specific information that can be used to generate targeted advertising by the ad server 30. A user identifier (user ID) is assigned to that user.

As part of the registration process, the back-end server 20 downloads client code 16 (e.g., from the back-end server 20, a compact disc, or other suitable source) to the client computer 10. The client code 16 may be code separate from the browser 14 or may be an add-on tool that integrates into the user's browser. In some embodiments, the client code 16 automatically downloads and extracts without the user having to do anything other than register him or herself. The client code may thus comprise browser add-on/overlay code that contains no spyware, malware or any other malicious code, in some embodiments, the client code 16 is only installed after a user proactively registers with the online advertising service. In some embodiments, the code 16 is not surreptitiously or forcibly installed.

Once the client code 16 is installed on the client computer 10, the client code 16 first determines the screen resolution of the display 12 when a user opens a Web browser. The screen resolution may be obtained by way of an operating system (OS) call or other suitable mechanism. The screen resolution correlates to the size of the “unused” areas of a Web browser. These unused areas are bounded between a Web site being displayed on the user's display and the boundaries of the inner frame edges of the user's browser window. This determination of the size of the unused areas is performed within a fraction of a second and thus with little or no user-perceptible lag or delay. This technique is illustrated by way of FIGS. 2-4, each of which is now described in turn.

FIG. 2 shows a conventional browser window 50. The window 50 displays a Web page 52. On either side of the Web page 52 is an unused area: unused area 54 on the left side and unused area 56 on the right side. The Web page 52 does not extend into these areas due to a difference between the size of the displayed Web page 52 and the resolution and size of the browser window 50. The size of the unused areas, in terms of the number of pixels in the horizontal and vertical directions, is a function of the resolution of the client computers display 12. As explained above, the client code 16 obtains this resolution information from the client computer 10.

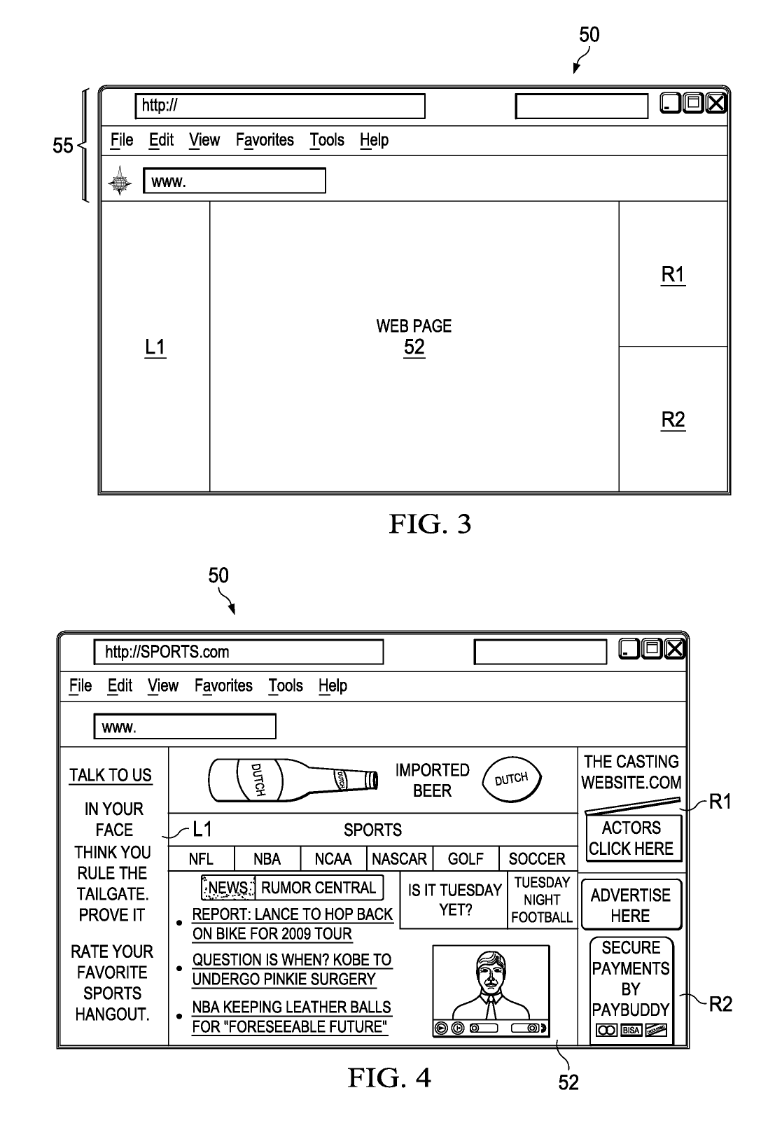

FIG. 3 shows a layout view of the browser window 50 in accordance with preferred embodiments of the invention. As shown in FIGS. 2-3, the Web page 52 occupies a center area. The client code 16 assigns and populates the unused areas 54 and 56 with L1, R1 and R2 rectangles, as shown. The sizes of the rectangles L1, R1 and R2 are determined by the client code 16 based on the screen resolution. Part or all of the left side rectangle L1 (or “rail”) is designated as a single “skyscraper” size dynamic ad (or “motion” ad). This ad in L1 may span the entire height of the browser window 50, except for the browser access fields 55 toward the top of the browser window 50. The unused area on the right side (rail) is divided into two advertising areas (rectangles R1 and R2 which, in some embodiments, are equal in size). Each of the rectangles R1 and R2 preferably is one-half the height of the left-side rail. Dynamic ads may be displayed in R1, while static banners may be displayed in R2. Conversely, static banners may be displayed in R1, while dynamic banners may be displayed in R2. The use of each of the three rectangles may be varied as desired. Further, any number of rectangles and/or other shapes may be used in lieu of the embodiment shown in FIGS. 3-4. In some embodiments, ads displayed in this manner do not scroll with the Webpage. Thus, for instance, if a user scrolls downward so that the Web browser displays different information, the ads remain fixed in place. The ads remain in place because, although they are displayed within the Web browser 14, they are not actually part of the Web page being retrieved online.

When a user launches the browser 14, the client computer 10 notifies the back-end server 20 that the user is online and browsing the Internet. The client code 16 reports the user's user ID to the back-end server 20. In turn, the back-end server 20 notifies the accounting database 22 that the user is online and commands it to begin measuring the length of time that the user is online. The accounting database 22 measures this time and records the time in the accounting database 20 so that the user's account is up-to-date.

Because the user is paid for the length of time that he or she is online, the length of time is used to calculate money owed to the user. The accounting database 22 may contain the user's bank account information (account number, routing number, etc.) so that the funds may be transferred directly to the user's bank account, credit card, debit card, etc. Alternatively, the accounting database 22 may contain a user address to which payment may be sent.

When a user goes online, the profile database 24 notifies the ad server 30 that a particular user (e.g., by user ID) is online. The profile database 24 also provides the users profile (age, gender, location, income, ethnic background, etc.) to the ad server 30 to determine ad content 32 suitable and targeted for that particular user. The targeted ad content 32 is then transmitted across the Internet 25 to the client's browser 14 for display in rectangles L1, R1 and R2. FIG. 4 illustrates the placement of ads in rectangles L1, R1 and R2.

The sizes of the rectangles (e.g., rectangles L1, R1 and R2) are functions of the screen resolution of the user's display 12. When the user initially runs the browser 14, the client code 16 obtains the screen resolution of the display 12 and reports the resolution to the back-end server 20. The back-end server 20 (and more specifically, the profile database 24) forwards the screen resolution to the ad server 30. The ad content 30 dictates the size of the client computer's L1, R1 and R2 rectangles based on the reported screen resolution. The ad server 30 selects and/or generates targeted ad content for the client computer 10. The targeted ad content fits the rectangles L1, R1 and R2. The ad content, targeted for the specific user and sized according to the client computer's unused area (and, more specifically, rectangles L1, R1 and R2), is then provided to the client computer for display as an overlay to the client's Web browser.

In some cases, a mismatch may exist between the client's display resolution and the targeted ad content that has been preconfigured for various display resolutions. In such a case, the targeted ads will not exactly fit the client's rectangles L1, R1 and R2. To address this problem, in some embodiments, the ad server 30 provides the client computer with an information window that pops up on the client's display 12. In some embodiments, the information window alerts the user that there is a problem with the display resolution of the user's display and that the system will, if the user agrees by clicking a confirmation button, adjust the users display resolution. If the user accepts by clicking the confirmation button, the ad server 30 commands the client computer to adjust the display resolution to a specified level. In other embodiments, the pop-up window may inform the user to manually adjust the display resolution. In such embodiments, the information window may specify which resolution or resolutions are acceptable.

At pre-defined or programmable intervals (e.g., every 30 seconds), the ad server 30 may change the ad content provided to the client computer. At that rate, a user may see three ad impressions every 30 seconds (i.e., one ad during the 30 seconds in each of the three rectangles, L1, R1 and R2), six impressions per minute (i.e., two ads during the minute in each of the three rectangles, L1, R1 and R2), or 360 impressions per hour (i.e., one hundred twenty ads during the hour in each of the three rectangles, L1, R1 and R2). Other rates also may be used.

To avoid paying a user who turns on and leaves the browser 14 and client code 16 unattended for long periods of time, in some embodiments, the back-end server 20 (e.g., the accounting database 22) implements a feature to ensure the user of the client computer 10 is still present and located in front of the computer 10. Specifically, the back-end server 20 transfers a message to the ad server 30 at a periodic rate (e.g., once per hour) to interrupt ad service to the client computer 10. The ad server 30 responds by ceasing its ad service and instead provides a user query to one or more of the rectangles L1, R1 and R2. The query requests the user to “click” on a button in the query box. If the user clicks the button, the ad server 30 determines or assumes that the user is still present and continues serving ads. If the query button is not clicked within a predetermined time period (e.g., one minute), the ad server 30 causes the back-end server's accounting database 22 to cease crediting the user's account with time spent surfing the Web. Other permutations of this mechanism also are included within the scope of this disclosure.

When determining which ads to send to a particular user, the ad server 30 matches the user's registration data with predetermined criteria from advertisers. In this way, ads are targeted to the user based on information in the user profile, such as age, sex, interests, income, etc. Thus, for example, a 25-year-old male from New York City sees ads appropriate for him, such as ads for running shoes, cars, New York restaurants, etc. He will not see ads suited for other demographics, such as ads for feminine hygiene products, AARP, California political candidates, etc. Unlike TV, radio or newspapers, which are “one-to-many” media platforms, the system described herein is a “one-to-one” ad medium. The matching of users and advertisers mitigates waste of the advertiser's advertising dollars. The data-based demographic model described herein also enables advertisers to achieve an exponentially greater return-on-investment (ROI) in comparison to other advertising methods. Targeted or untargeted ads can be placed in otherwise unused rectangles L1, R1, and R2.

The system disclosed herein is “net neutral,” meaning that modifications made to the user's Web-browser/Web-browsing experience are local to the user's computer. Few to no modifications are made to a Website's source code. Moreover, in at least some embodiments, the system (client code 16, back-end server 20 or ad server 30) does not read user cookies; track clicks of users; use Deep Packet Injection; alter a Website (e.g., replace ads, shrink a Website to make room for ads, etc.); work without user permission, use malicious code; or modify software of, hijack or redirect Web browsers.

In order to see the “unused areas” the screen resolution of display 12 optimally should, in at least some embodiments, be set to a width of 1280 pixels or higher and the browser window should operate in full screen mode. When a user first downloads the application (client code 16), the code detects the user's screen resolution. If the resolution is not optimal (e.g., 1280 pixels or higher), the application 16 determines whether the user would like the screen resolution changed to an appropriate level, or if the user would like to adjust the screen resolution manually (e.g., via “control panel”).

The client code 16 also has a native Mouse Overlay (“MO”) mode which enables advertisements to still be displayed even with incompatible screen resolutions (i.e., incompatible with the client code's ability to place ads in unused areas L1, R1, and R2, as there may not be any such unused areas or the unused areas may be too small relative to the ad sizes). For such incompatible screen resolutions (i.e., the ads cannot be placed in unused areas of the browser window without overlaying part of the browser content), in MO mode the ads will appear superimposed over some browser content (and thus the ads will block or obscure such browser content), but will temporarily become transparent or translucent in order to view the underlying browser content when the mouse pointer is placed over the ads. In some embodiments, only the ad being “moused over” becomes transparent or translucent, while in other embodiments, all of the ads become transparent or translucent when any of the ads are moused over. In some embodiments, the user will not be credited for the duration of transparency or translucency of any ad moused over. The MO mode can be “toggled” on and off (i.e., enabled/disabled) by the user at will via a user setting. In some embodiments, if the client code 16 is being used with a non-optimal screen resolution, the MO mode will default to an always-on posture.

The client code 16 also has a “turbo mode” that permits ads to be displayed without a browser window being open. In turbo mode, the client code 16 receives the ads from the ad server 30 in a background mode of operation and renders the ads directly on the client computer's “desktop”—for example, on the left and right edges of the desktop (i.e., as if the desktop itself was the browser window described above). The turbo mode can be toggled on and off, as desired, via a user setting. In some embodiments, if the Web browser 14 is open, the ads are placed in the unused areas of the browser's window, as discussed previously. If the user's browser is not open and running or is minimized, the client code 16 enables the turbo mode and the ads are displayed on the desktop. Thus, switching between turbo mode (in which ads are shown on the desktop) and the non-turbo mode of operation (in which ads are shown in the unused areas of the browser) may occur automatically, depending on whether or not the client code is visible on the desktop.

In yet other embodiments, ads can be placed on screen during the user's performance of an online search. Private personal information (PPI) that is provided by the user at registration is used with their permission as a means to refine, weight and display demographically targeted search results, sponsored search results and contextual ads within search results. This allows any search engine to utilize the methodology delineated herein, in addition to and as a means of further refining their current algorithmically generated results and ads. In so doing, this allows the search engine to be able to charge a higher rate for their search engine ads, sponsored search results and contextual ads as the method disclosed herein allows for a more targeted and accurate fit to the actual, as opposed to the current algorithmically postulated, user.

In yet another embodiment associated with online searching, a “search box” is provided in one of the onscreen spaces allocated to display the user's real-time earnings data (i.e., in addition to, and not in lieu of, that data). Such search function is referred to by the working title “I Want/I Need”. In this embodiment of the invention, the “I Want/I Need” search function is integrated with an online search engine, so that the search results are filtered and the results that are provided are limited to good and services appropriate for the user based upon the user's PPI data. When the user types a search query in the “I Want/I Need” search box and hits the search button, two things happen. First, the query is transmitted to the search engine site and the search engine site generates a result for the search that is displayed in a new browser window that is opened for such purpose. To enhance the efficacy of such search results, the search engine may be sent the user's zip code, gender and age data (i.e., from the demographic PPI data that the user has given at registration) so that the search engine can “weight” the search results and contextual ads more effectively. Second, the search query term is also sent to the ad server of this invention so that ads relevant to the user's search may be displayed either in addition to or in lieu of the search engine ads.

In yet other embodiments, ads can also be provided to a user's television. The ads may be transmitted via, for example, a cable signal. At least some high definition broadcasts inherently result in left and right side bars, or empty areas, on the broadcast image where the broadcast image is smaller than the television display capabilities. The ads can then be provided on the left and right bars of the television screen (and/or top/bottom of the screen). The ad content in such embodiments is mixed with the broadcast signal at the head end of the master system operator (MSO). Thus, the ad signal is inserted at the MSO's “Head End.” The ad may comprise a data stream/video signal that “piggybacks” on a particular signal for a digital channel from the cable system. The resulting ad content displayed in conjunction with a TV broadcast signal would function similar to the non-mouse over mode of the client code 16. If display space inherently exists on a transmitted HD or digital channel, providing unused space on the left and right of the viewer's screen between the edges of the broadcast image and the edges of the displayable area of the screen, the system would use that space for ads. The user's remote control would be used in place of the mouse on a computer for user input. Registration of such users could be, for example, by way of the remote control, or by calling the cable (or satellite, etc.) service provider to sign up for the ad functionality.

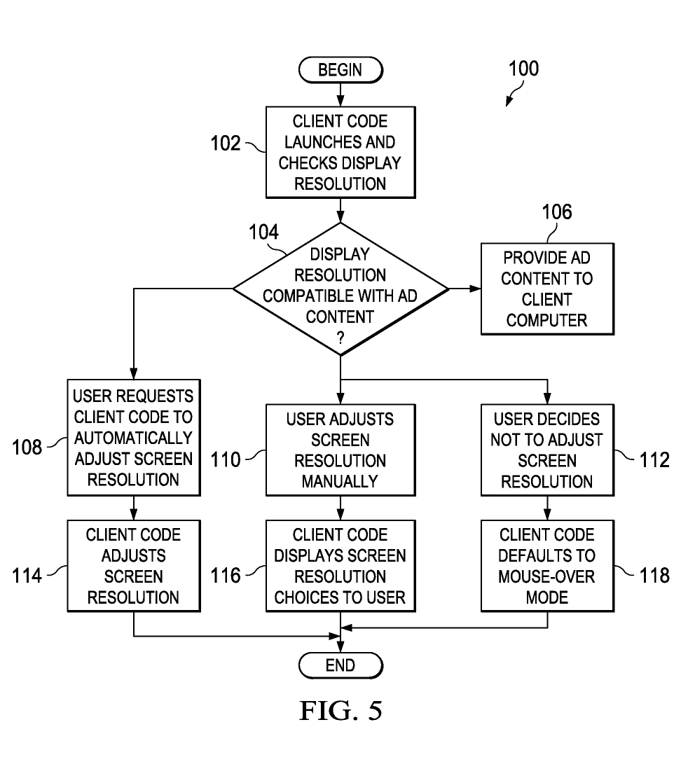

FIG. 5 illustrates the operational flow 100 of the client code 16 in accordance with at least some embodiments. At 102, the client code 16 is launched by, for example, the user or automatically upon the user running browser 14 or is launched automatically upon booting up client computer 10. The client code 16 checks the display resolution as explained previously. At 104, if the display resolution is compatible with the online ad content to be provided to the client computer (e.g., resolution is 1280 pixel width or higher), then no action is required to adjust the resolution of the display 12 and the ad content can begin to be provided to the client computer by the ad server 30 (block 106).

If, however, the display resolution is not compatible with the online ad content to be provided to the client computer (e.g., the resolution is less than 1280 pixel width), then the resolution should be changed. The user is notified by client code 16 of this problem. One of at least three subsequent actions can be taken to address this issue. At 108, the user requests the client code 16 to automatically adjust the screen resolution to a level compatible with the ad content. Then, at 114, the client code 16 automatically adjusts the screen resolution to a compatible level, (e.g., 1280 pixel width or higher). If desired, the mouse-over mode discussed above can be automatically enabled as well.

Alternatively, at 110, the user adjusts the screen resolution manually (via a software interface to the operating system of client computer 10). The client code, at 116, displays one or more compatible screen resolution choices to the user from which the user can use to manually adjust the resolution. If desired, the mouse over mode discussed above can be automatically enabled as well.

At 112, the user may alternatively decide not to adjust, or have adjusted, the screen resolution. If so, then at 118, the client code defaults to the mouse over mode discussed above.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
obtaining a user profile from a user who registers with an online service;
providing the user profile to an ad server;
receiving from the ad server a targeted ad based on the user profile; and
displaying the targeted ad in an unused area of a browser window as an overlay to the browser window.

2. The method of claim 1 further comprising monitoring a length of time said targeted ad is viewed and compensating said user in accordance with said length of time.

3. The method of claim 1, further comprising said unused area into three sections, said targeted ad displayed in a first of said three sections and additional ads displayed in a second and a third of said three sections.

4. The method of claim 3, wherein the first section is located on a left side of a Webpage displayed in the browser window and said second and third sections are located on a right side of said Webpage.

5. The method of claim 1 further comprising determining whether a display resolution is compatible with said targeted ad, and if said display resolution is incompatible with said targeted ad, then as a result, automatically adjusting said display resolution to be in accordance with said targeted ad.

6. The method of claim 1, wherein said unused area is bounded by a Web page displayed in said browser window and by borders of the browser window.

7. A system, comprising:
a processor; and
storage comprising an accounting database;
wherein the processor updates the accounting database with data indicating a length of time that ad content is displayed on a portion of a Web-browser, said portion not occupied by World Wide Web content.

8. The system of claim 7, wherein the processor uses said data to cause a user of the Web-browser to be financially compensated.

9. The system of claim 7, wherein said ad content obscures at least part of said World Wide Web content.

10. The system of claim 9, wherein said ad content that obscures said at least part of the World Wide Web content is made translucent or transparent when a cursor hovers over said ad content or over said World Wide Web content.

11. The system of claim 7, wherein said ad content obscures at least part of a desktop of said display.

12. The system of claim 11, wherein said ad content that obscures said at least part of the desktop is made translucent or transparent when a cursor hovers over said ad content or over said desktop.

13. A computer-readable medium comprising software which, when executed by a processor, causes the processor to:
generate a user profile comprising user data;
provide said user profile to another entity;
receive ad content that is selected based on said user data in the user profile; and
display said ad content in a portion of a Web browser not displaying information obtained online.

14. The computer-readable medium of claim 13, wherein said software launches automatically upon launching said Web browser.

15. The computer-readable medium of claim 13, wherein said processor determines a length of time a user views the ad content and causes the user to be compensated accordingly.

16. The computer-readable medium of claim 15, wherein said processor queries said user to determine whether the user is still viewing said ad content.

17. The computer-readable medium of claim 13, wherein said medium comprises a device selected from the group consisting of a personal computer, a compact disc, a server, a personal digital assistant and a television.

18. A method, comprising:
obtaining a user profile from a user who registers with an on-line service;
providing the user profile to an ad server;
the ad server providing a targeted ad based on the user profile;
displaying the targeted ad on a display and at least partially obscuring a web page or desktop; and
altering the displayed, targeted ad upon a user moving a cursor on top of the ad to thereby permit the previously obscured web page or desktop to be seen.

19. The method of claim 18, wherein said altering comprises an action selected from the group consisting of making transparent and making translucent.

20. The method of claim 18, wherein, if said targeted ad is incompatible with a resolution of said display, then as a result, automatically adjusting said resolution to be compatible with said targeted ad.

21. The method of claim 18, wherein said displaying comprises displaying the targeted ad on either side of the web page.

22. The method of claim 18, wherein said user profile comprises information selected from the group consisting of interests, income group, age and gender.

23. A method, comprising:
obtaining a user profile from a user who registers with an online service;
providing the user profile to an ad server;
receiving a search query from the user;
supplying such search query to an online search engine;
receiving search results to the search query from the search engine;
receiving from the ad server a targeted ad based on the user profile; and
displaying the search results and the targeted ad in an unused area of a browser window as an overlay to the browser window.

24. The method of claim 23, further comprising supplying the search engine with user profile information in order to allow the search engine to provide a second targeted ad with the search results.

25. The method of claim 24, further comprising the notifying the search engine that the search query seeks unique goods or services information in order to allow the search engine to filter the second targeted ad provided by the search engine.

26. The method of claim 23 further comprising monitoring a length of time said targeted ad is viewed and compensating said user in accordance with said length of time.

27. The method of claim 23, further comprising said dividing the unused area into at least two sections, said targeted ad displayed in a first of said sections and additional ads displayed in the other of said sections.

28. The method of claim 27, wherein the first section is located on a left side of a Webpage displayed in the browser window and said other sections are located on a right side of said Webpage.
